(19) United States
(12) Patent Application Publication
(10) Pub. No.: US 2018/0300341 A1
(43) Pub. Date: Oct. 18, 2018

(54) SYSTEMS AND METHODS FOR IDENTIFICATION OF ESTABLISHMENTS CAPTURED IN STREET-LEVEL IMAGES

(71) Applicant: International Business Machines Corporation, Armonk, NY (US)

(72) Inventors: Eitan HADAR, Nesher (IL); Joseph SHTOK, Haifa (IL)

(21) Appl. No.: 15/489,755

(22) Filed: Apr. 18, 2017

(51) Int. Cl. G06F 17/30; G06K 9/62

(52) U.S. Cl. CPC G06F 17/3087; G06F 17/30241; G06F 17/30268; G06K 9/6218; G06F 17/30256; G06K 9/627; G06K 9/6202; G06F 17/3028

(57) ABSTRACT

There is provided a computer implemented method of classifying an establishment within a street-level image into an establishment-category for indexing by a search engine, the method comprising: receiving a street-level image and a geographic location, identifying at least one portion of the street-level image including a sign indicative of at least one establishment, classifying each of the at least one establishment into an establishment-category by matching each extracted sign image portion to a corresponding entry in an establishment-sign dataset, wherein entries of the establishment-sign dataset include at least one image of a certain sign and an associated establishment-category of the certain sign, creating, for the street-level image, metadata that stores each classified establishment-category and the geographic location, and providing the metadata for indexing by a search engine, wherein the indexed metadata is searchable for establishments satisfying at least one queried establishment-category within a queried geographical region.

### BACKGROUND

The present invention, in some embodiments thereof, relates to image processing and, more specifically, but not exclusively, to systems and methods for processing street-level images.

Contemporary visual urban mapping systems provide street-level imagery in addition to the aerial data. These images depict stores, banks, hotels, and other kinds of commercial and official institutions. Some of the commercial and official institutions are marked on an online two dimensional map.

### SUMMARY

According to a first aspect, a computer implemented method of classifying an establishment within a street-level image into an establishment-category for indexing by a search engine, the method comprising: receiving a street-level image and a geographic location, identifying at least one portion of the street-level image including a sign indicative of at least one establishment, classifying each of the at least one establishment into an establishment-category by matching each extracted sign image portion to a corresponding entry in an establishment-sign dataset, wherein entries of the establishment-sign dataset include at least one image of a certain sign and an associated establishment-category of the certain sign, creating, for the street-level image, metadata that stores each classified establishment-category and the geographic location, and providing the metadata for indexing by a search engine, wherein the indexed metadata is searchable for establishments satisfying at least one queried establishment-category within a queried geographical region.

According to a second aspect, a system for classifying an establishment within a street-level image into an establishment-category, the system comprising: a non-transitory memory having stored thereon a code for execution by at least one hardware processor of a computing device, the code comprising: code for receiving a street-level image and a geographic location, code for identifying at least one portion of the street-level image including a sign indicative of at least one establishment, code for classifying each of the at least one establishment into an establishment-category by matching each extracted sign image portion to a corresponding entry in an establishment-sign dataset, wherein entries of the establishment-sign dataset include at least one image of a certain sign and an associated establishment-category of the certain sign, code for creating, for the street-level image, metadata that stores each classified establishment-category and the geographic location, and code for providing the metadata for indexing by a search engine, wherein the indexed metadata is searchable for establishments satisfying at least one queried establishment-category within a queried geographical region.

According to a third aspect, a computer program product for classifying an establishment within a street-level image into an establishment-category, the computer program product comprising: a non-transitory memory having stored thereon a code for execution by at least one hardware processor of a computing device, the code comprising: instructions for receiving a street-level image and a geographic location, instructions for identifying at least one portion of the street-level image including a sign indicative of at least one establishment, instructions for classifying each of the at least one establishment into an establishment-category by matching each extracted sign image portion to a corresponding entry in an establishment-sign dataset, wherein entries of the establishment-sign dataset include at least one image of a certain sign and an associated establishment-category of the certain sign, instructions for creating, for the street-level image, metadata that stores each classified establishment-category and the geographic location, and instructions for providing the metadata for indexing by a search engine, wherein the indexed metadata is searchable for establishments satisfying at least one queried establishment-category within a queried geographical region.

The systems and/or methods and/or code instructions stored in a storage device executed by one or more processors described herein provide a technical solution to the technical problem of automatically indexing establishment-categories of establishments captured in street-level images to create a searchable dataset. For example, in comparison to other methods that create searchable datasets based on otherwise manually entered data, which may be incomplete and/or incorrect. Establishments, for example small establishments with a single location (i.e., not part of a retail chain, franchise, and/or distribution network) may not be associated with metadata searchable by a map search engine, and/or may not be associated with metadata that is presented with the street-level image that includes the establishment. For example, a search for restaurants in London may retrieve results for large well known restaurants, but may omit results for small independent restaurants, and/or omit all locations of a retail chain and/or franchise of restaurants.

The technical problem may relate to automatically creating metadata for indexing by a search engine, where the metadata includes establishment-categories of establishments having signs captured in street-level images, where the sign of the establishment includes image(s) which cannot be accurately interpreted and/or accurately recognized according to standard methods, for example, according to optical character recognition (OCR) methods. The technical solution provided by systems and/or methods and/or code instructions stored in a storage device executed by one or more processors described herein is based on visually matching the image of the sign to an entry in the establishment-sign dataset that is performed according to the extracted image of the sign, rather than the text of the sign. The sign which may include image(s), a graphic, a picture, logo(s), a foreign language, font(s) that cannot be correctly converted into text (e.g., according to OCR), and/or text that is formatted in a non-standard format which prevents recognition according to standard formats (e.g., according to OCR). Matching according to the extracted image of the sign (e.g., rather than the text of the sign) improves the accuracy of matching to an entry, and/or improves the probability of matching to an entry, and/or enables matching to entries that would otherwise be unmatchable (e.g., when the sign does not include text that is recognizable according to OCR). The metadata is created based on the data of the entry matched according to the image.

It is noted that in cases when the sign includes text that may be extracted according to OCR, the systems and/or methods and/or code instructions described herein may treat the text as an image, and match the image of the text, optionally by extracting visual features from the image of the text.

The systems and/or methods and/or code instructions stored in a storage device executed by one or more processors described herein improve performance of a computing unit that performs a map based search for establishment-categories, by providing the metadata for indexing by the search engine. For example, the metadata created based on the automatic identification of the establishment-categories of establishments according to images of extracted signs captured in street-level images improves the probability of the map based search engine to return relevant results to search queries. The relevant results reduce the additional processing time and/or computation resources which would otherwise be required by the user entering multiple queries in an attempt to perform the search for the establishment-category according to the map search engine.

In a first possible implementation form of the method according to the first or the system according to the second aspect or the computer program product according to the third aspect, the matching is performed based on visual features extracted from the portion of the street-level image that are matched to visual features stored in the establishment-sign dataset.

In a second possible implementation form of the method or the system or the computer program product according to the first or second or third aspects as such or according to any of the preceding implementation forms of the first or second or third aspects, receiving comprises receiving a plurality of street-level images of a geographical region, wherein identifying comprises identifying a plurality of portions of the plurality of street-level images each including a sign indicative of a respective establishment, and further comprising: clustering the plurality of establishments of the geographical region according to the respective classified establishment-categories, and identifying establishment members of each cluster of establishment-categories according to a common indication.

In a third possible implementation form of the method or the system or the computer program product according to the first or second or third aspects as such or according to any of the preceding implementation forms of the first or second or third aspects, the method further comprises, and/or the system and/or computer program product further comprise code instructions for: receiving a textual search query for a certain establishment-category and a certain geographical area, searching, according to the metadata, for the certain establishment-category and the certain geographical area, and presenting a distribution of establishments of the certain establishment-category within the certain geographical area.

In a fourth possible implementation form of the method or the system or the computer program product according to the third preceding implementation form of the first or second or third aspects, the method further comprises, and/or the system and/or computer program product further comprise code instructions for: performing a statistical analysis based on at least one establishment-category within a certain geographical area, according to the created metadata.

In a fifth possible implementation form of the method or the system or the computer program product according to the first or second or third aspects as such or according to any of the preceding implementation forms of the first or second or third aspects, receiving comprises receiving a plurality of street-level images of a geographical region, wherein identifying comprises identifying a plurality of portions of the plurality of street-level images including a plurality of sign indicative of a plurality of establishments, and further comprising: clustering the plurality of signs of the plurality of establishments according to common identified signs, and classifying the plurality of establishment members of each cluster into an establishment-category by matching the common identified sign of each cluster to the corresponding entry in the establishment-sign dataset.

In a sixth possible implementation form of the method or the system or the computer program product according to the fifth preceding implementation form of the first or second or third aspects, each cluster denotes at least one of: a retail chain, a franchise, and a distribution network of establishments with a plurality of branches at different locations within the geographical region, wherein the at least one of: retail chain, franchise, and distribution network of establishments is associated with a common sign.

In a seventh possible implementation form of the method or the system or the computer program product according to the first or second or third aspects as such or according to any of the preceding implementation forms of the first or second or third aspects, the identifying at least one portion of the street-level image including the sign is performed by code of a deep learning detector that is trained on a dataset of training street-level images with signs annotated with a polygon.

In an eighth possible implementation form of the method or the system or the computer program product according to the first or second or third aspects as such or according to any of the preceding implementation forms of the first or second or third aspects, the method further comprises, and/or the system and/or computer program product further comprise code instructions for: generating an overlay over a map that includes the geographical location from which the street-level image is acquired, the overlay including the establishment-category positioned according to the geographical location.

In a ninth possible implementation form of the method or the system or the computer program product according to the eighth preceding implementation form of the first or second or third aspects, the overlay further presents a cropped thumbnail of the identified at least one portion of the street-level image including the sign positioned according to the geographical location.

In a tenth possible implementation form of the method or the system or the computer program product according to the first or second or third aspects as such or according to any of the preceding implementation forms of the first or second or third aspects, the at least one portion of the street-level image including the sign includes at least one of a logo, a picture, and a trademark of the establishment, and the establishment-sign dataset includes at least one of a logo database, a picture database, and a trademark database.

In an eleventh possible implementation form of the method or the system or the computer program product according to the first or second or third aspects as such or according to any of the preceding implementation forms of the first or second or third aspects, the establishment-sign dataset is automatically created by performing: receiving a plurality of street-level images, identifying a plurality of portions from the plurality of street-level images including a plurality of signs, clustering the plurality of signs according to visual features extracted from each sign, crawling, using web crawler code instruction executable by at least one hardware processor, along web documents of a network, collecting at least one of logos and trademarks of establishments and data indicative of the establishment-category associated with the at least one of logos and trademarks, creating a plurality of entries of the establishment-sign dataset by visually matching the collected at least one of logos and trademarks of establishments to respective clusters of signs and including within each respective entry the data indicative of the respective establishment-category.

In a twelfth possible implementation form of the method or the system or the computer program product according to the first or second or third aspects as such or according to any of the preceding implementation forms of the first or second or third aspects, the method further comprises, and/or the system and/or computer program product further comprise code instructions for: obtaining a geographic location of the establishment from the corresponding entry of the establishment-sign dataset, and storing within the created geo-tag of the street-level image, the identified portion of the street-level image including the sign based and the geographic location of the establishment.

In a thirteenth possible implementation form of the method or the system or the computer program product according to the first or second or third aspects as such or according to any of the preceding implementation forms of the first or second or third aspects, the method further comprises, and/or the system and/or computer program product further comprise code instructions for: detecting a discrepancy between the geographic location of the created geo-tag for the street-level image that stores the establishment-category for each identified portion of the street-level image including the sign, and a previously created geo-tag of the street-level image.

In a fourteenth possible implementation form of the method or the system or the computer program product according to the first or second or third aspects as such or according to any of the preceding implementation forms of the first or second or third aspects, the method further comprises, and/or the system and/or computer program product further comprise code instructions for: detecting a discrepancy between an existing manually entered establishment-category associated with the street-level image and the classified establishment-category.

In a fifteenth possible implementation form of the method or the system or the computer program product according to the first or second or third aspects as such or according to any of the preceding implementation forms of the first or second or third aspects, the method further comprises, and/or the system and/or computer program product further comprise code instructions for: accessing an advertising database to retrieved at least one stored advertisement of at least one of products and services associated with the establishment-category, and presenting the at least one advertisement in association with at least one of the street-level image and a map of a location of the establishment.

In a sixteenth possible implementation form of the method or the system or the computer program product according to the first or second or third aspects as such or according to any of the preceding implementation forms of the first or second or third aspects, the method further comprises, and/or the system and/or computer program product further comprise code instructions for: providing the metadata for indexing of the street-level image according to each classified establishment-category and the geographic location, wherein the indexed street-level image is searchable according to a search query of a certain establishment-category.

In a seventeenth possible implementation form of the method or the system or the computer program product according to the first or second or third aspects as such or according to any of the preceding implementation forms of the first or second or third aspects, the method further comprises, and/or the system and/or computer program product further comprise code instructions for: rectifying the identified portion of the street-level image including the sign to a geometric shape, computing a sub-geographic location of the sign within the street-level image according to at least one of streets and buildings associated with the geographic location of the street-level image, wherein the geographic location of the street-level image is obtained from at least one of: a geotag created by the camera that captured the street-level image and map service information obtained from a mapping server that stores geographic locations of at least one of streets and buildings, and storing within the metadata the sub-geographic location of the sign.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a street-level image from London, England, for illustrating the technical problem addressed by the systems and/or methods and/or code instructions described herein, in accordance with some embodiments of the present invention;

FIG. 2 includes exemplary images of signs identified and extracted from street-level images, where the signs cannot be accurately interpreted and/or accurately recognized using standard methods, and which are identified, extracted, and matched to an establishment-category, in accordance with some embodiments of the present invention;

FIG. 3 is a flowchart of a method of creating a metadata for indexing by a search engine according to an establishment classified into an establishment-category based on an image of a sign extracted from a street-view image, in accordance with some embodiments of the present invention;

FIG. 4 is a block diagram of components of a system for receiving as input a street-view image, extracting an image of a sign indicative of an establishment, classifying the establishment into an establishment-category by matching the image of the sign to an entry in an establishment-sign dataset, and creating metadata for indexing by a search engine, in accordance with some embodiments of the present invention;

FIG. 5 is a flowchart depicting features that are executed based on the indexed metadata and/or based on the establishment-category dataset, in accordance with some embodiments of the present invention;

FIG. 6A depicts automatically identified signs from the street-level image of FIG. 1, in accordance with some embodiments of the present invention;

FIG. 6B includes images of cropped signs identified and extracted from street-level images, in accordance with some embodiments of the present invention;

FIG. 7A is an example of a map without the overlay created by the systems and/or methods and/or code instructions described herein, in accordance with some embodiments of the present invention;

FIG. 7B includes an overlay over the map of FIG. 7A that includes cropped images of signs extracted from the street-level image(s), in accordance with some embodiments of the present invention; and

FIG. 7C is a street-level image that includes sign(s) extracted and presented with the overlay of FIG. 7B, in accordance with some embodiments of the present invention.

### DETAILED DESCRIPTION

The present invention, in some embodiments thereof, relates to image processing and, more specifically, but not exclusively, to systems and methods for processing street-level images.

As used herein, the term establishment means a specific business, a public institution, and a private institution open to the public, for example, Mike's bar, The People's Bank, Jack Smith Art Gallery, and Fancy Hotel.

As used herein, the term establishment-category means a class of the businesses, public institutions, and private institutions open to the public, for example, law firm, government office, bank, restaurant, clothing store, art museum, hotel, theater, zoo, and historic home open for visitation by the public. Each establishment-category includes multiple establishments. For example, Jerry's and Fine Dining are establishments of the establishment-category restaurant. The establishment-category may be a hierarchical data structure, for example, the establishment-category restaurant may include the sub-categories of: fast food, Chinese food, Italian food, and Sea Food.

An aspect of some embodiments of the present invention relates to systems and/or methods and/or code instructions stored in a storage device executable by processor(s) for classifying an establishment into an establishment-category based on a sign of the establishment that includes an image(s), extracted from a street-view image. The establishment is classified by matching the image(s) of the sign (and/or visual features extracted from the sign) to an entry in an establishment-sign dataset that stores images of signs (and/or visual features) and associated establishment-categories. The establishment-category is automatically associated with the street-view image. Metadata storing the establishment-category and an associated geographic location is automatically created for the street-level image, for example, as a geo-tag, which may be formatted for indexing by a search engine. The geographic location may be obtained from the matching entry in the establishment-sign dataset and/or from a positioning device that outputs the geographical position of the camera that captured the street-level image. The metadata is provided for indexing by a search engine, where the indexed metadata is searchable for establishments satisfying at least one queried establishment-category within a queried geographical region. A statistical analysis may be performed based on the indexed metadata.

Optionally, multiple street-view images obtained over a geographic region are analyzes to extract multiple signs of establishments, to classify the multiple establishments into establishment-categories. The establishments of the geographic region are clustered based on the associated establishment-category. The establishment members of each cluster are identified according to a common indication. For example, all restaurants (of all retail chains, all franchises, all branches of each retail chain and/or each franchise, all distribution nodes (e.g., food chart), and independent restaurants with a single location) within the geographic region are identified.

A textual search query may be executed according to the indexed metadata to search for establishments according to the establishment-category and geographic location. For example, a search for restaurants may be performed within a sub-portion of the geographic region. The search may return street-view images of the restaurants found within the geographic region.

A statistical analysis may be performed according to the indexed metadata, for one or more establishment-categories (e.g., based on the establishment members of one or more clusters) within the geographic region or a sub-portion of the geographic region. For example, the number of restaurants within the geographic region, density of restaurants within the geographic region, and distances between restaurants. The statistical analysis may be used by a user looking to open a new restaurant, for example, to determine which geographical location is lacking in restaurants accordingly to density, and/or to determine a location that is far from other restaurants in a region that already includes several restaurants.

The systems and/or methods and/or code instructions stored in a storage device executed by one or more processors described herein provide a technical solution to the technical problem of automatically indexing establishment-categories of establishments captured in street-level images to create a searchable dataset. For example, in comparison to other methods that create searchable datasets based on otherwise manually entered data, which may be incomplete and/or incorrect. Establishments, for example small establishments with a single location (i.e., not part of a retail chain, franchise, and/or distribution network) may not be associated with metadata searchable by a map search engine, and/or may not be associated with metadata that is presented with the street-level image that includes the establishment. For example, a search for restaurants in London may retrieve results for large well known restaurants, but may omit results for small independent restaurants, and/or omit all locations of a retail chain and/or franchise of restaurants.

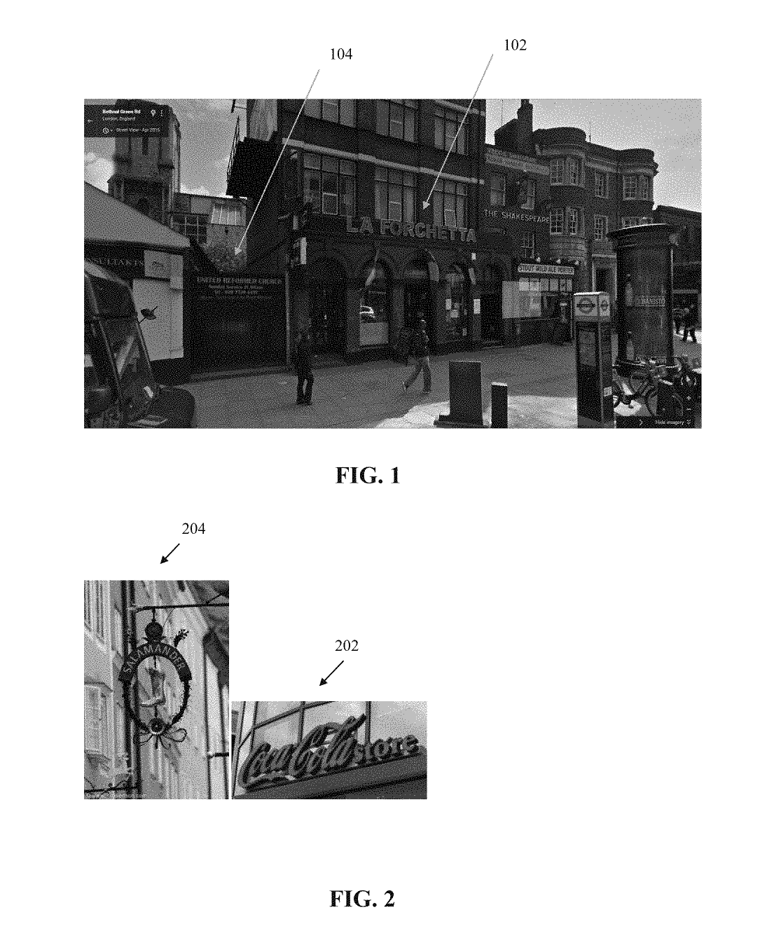

Reference is now made to FIG. 1, which is a street-level image from London, England, for illustrating the technical problem addressed by the systems and/or methods and/or code instructions described herein, in accordance with some embodiments of the present invention. The establishment associated with the sign “IA FORCHETTA” 102 is a restaurant that is searchable by entering a text based search query into a map search engine that stores a manually entered entry. Searching for “LA FORCHETTA” 102 using the map search engine retrieves the street-level image depicted in FIG. 1, and/or retrieves a map of the street shown in the street-level image with an indication of the location of “IA FORCHETTA” 102. In contrast, a search using the map search engine for the adjacent establishment with the sign “United Reformed Church” 104 does not retrieve the street-level image depicted in FIG. 1, and/or does not retrieves the map of the street shown in the street-level image with an indication of the location of the “United Reformed Church”.

The technical problem may relate to automatically creating metadata for indexing by a search engine, where the metadata includes establishment-categories of establishments having signs captured in street-level images, where the sign of the establishment includes image(s) which cannot be accurately interpreted and/or accurately recognized according to standard methods, for example, according to optical character recognition (OCR) methods. The technical solution provided by systems and/or methods and/or code instructions stored in a storage device executed by one or more processors described herein is based on visually matching the image of the sign to an entry in the establishment-sign dataset that is performed according to the extracted image of the sign, rather than the text of the sign. The sign which may include image(s), a graphic, a picture, logo(s), a foreign language, font(s) that cannot be correctly converted into text (e.g., according to OCR), and/or text that is formatted in a non-standard format which prevents recognition according to standard formats (e.g., according to OCR). Matching according to the extracted image of the sign (e.g., rather than the text of the sign) improves the accuracy of matching to an entry, and/or improves the probability of matching to an entry, and/or enables matching to entries that would otherwise be unmatchable (e.g., when the sign does not include text that is recognizable according to OCR). The metadata is created based on the data of the entry matched according to the image.

It is noted that in cases when the sign includes text that may be extracted according to OCR, the systems and/or methods and/or code instructions described herein may treat the text as an image, and match the image of the text, optionally by extracting visual features from the image of the text.

Reference is now made to FIG. 2, which includes example images of signs identified and extracted from street-level images, where the signs include image(s) which may not be accurately interpreted and/or accurately recognized according to standard methods, and which are identified, extracted, and matched to an establishment-category, in accordance with some embodiments of the present invention. CocaCola store sign 202 is written in a font that cannot be correctly converted into text according to OCR. SALAMANDER sign 204 is formatted according to an arc, which cannot be correctly converted into text according to OCR. The systems and/or methods and/or code instructions described herein treat CocaCola store sign 202 and SALAMANDER sign 204 as an image, and perform matching of the image (and/or of visual features extracted from the image).

The systems and/or methods and/or code instructions stored in a storage device executed by one or more processors described herein automatically identify the establishment-category of an establishment by analyzing the image of the extracted sign of the establishment within a captured street-level image. The establishment-category may not necessarily be easily determined by a user that sees a sign for an establishment on a street-level image. For example, the establishment-category of an establishment having a sign for Jack's House is not easily derivable, since Jack's House may refer to a bar, a restaurant, a hotel, a museum, and an outdoor clothing store.

The systems and/or methods and/or code instructions stored in a storage device executed by one or more processors described herein improve performance of a computing unit that performs a map based search for establishment-categories, by providing the metadata for indexing by the search engine. For example, the metadata created based on the automatic identification of the establishment-categories of establishments according to images of extracted signs captured in street-level images improves the probability of the map based search engine to return relevant results to search queries. The relevant results reduce the additional processing time and/or computation resources which would otherwise be required by the user entering multiple queries in an attempt to perform the search for the establishment-category according to the map search engine.

The systems and/or methods and/or code instructions stored in a storage device executed by one or more processors described herein improve an underlying technical process within the technical field of image processing, in particular, within the field of automatically creating metadata for indexing by a search engine based on an analysis of signs of establishments captured in street-level images.

The systems and/or methods and/or code instructions stored in a storage device executed by one or more processors described herein are tied to physical real-life components, including one of more of: a camera, a geographical location device, street-level images of real-life streets stored in a data storage device, and the establishment-sign dataset stored in a data storage device.

Accordingly, the systems and/or methods and/or code instructions described herein are inextricably tied to computing technology and/or physical components to overcome an actual technical problem arising in processing of street-level images.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As used herein, the term identified sign, or sign sometimes refers to the portion of the street-level image that includes the sign.

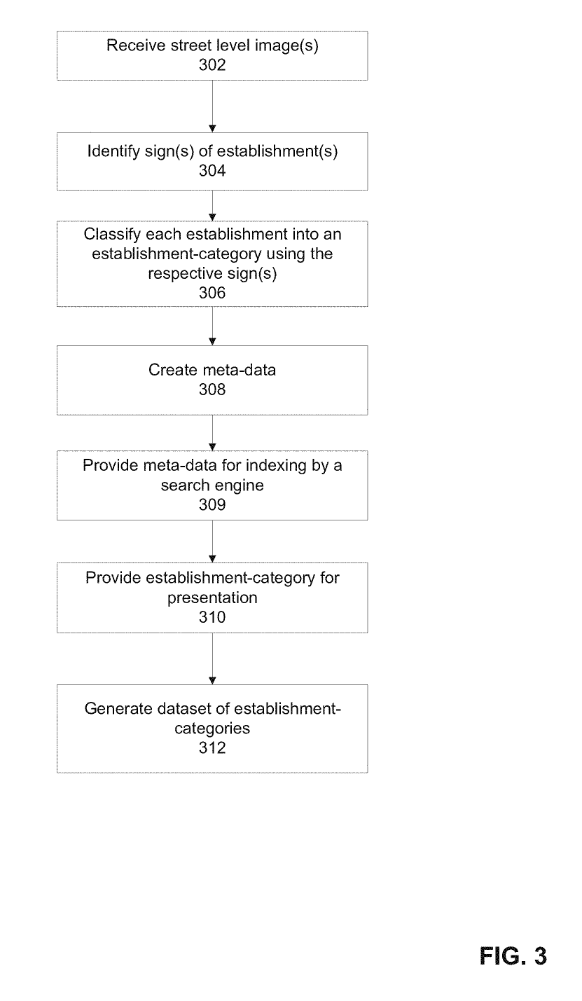

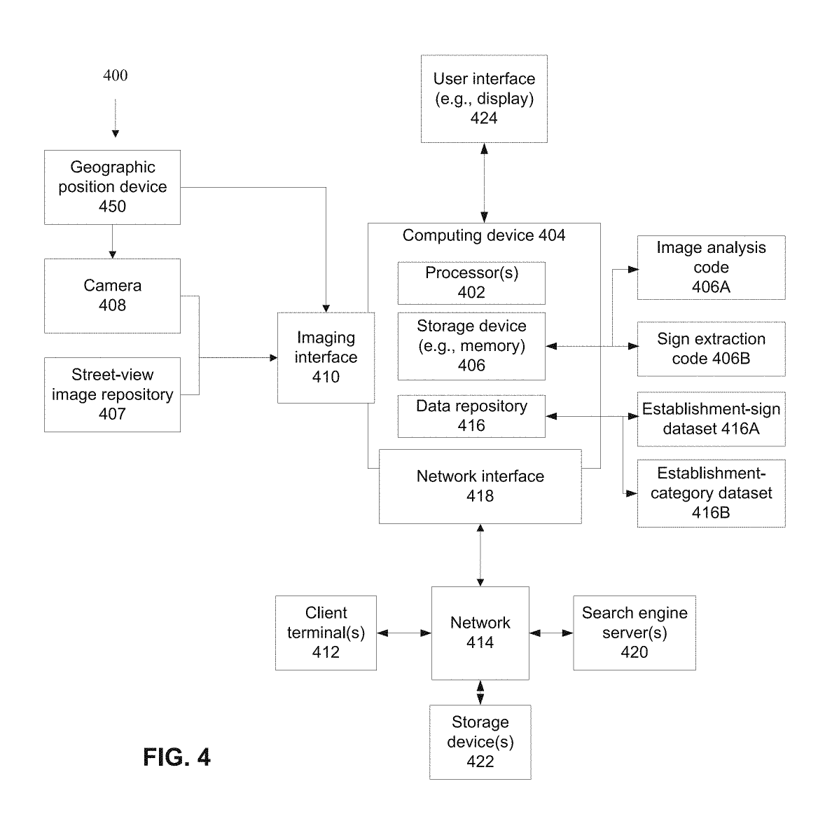

Reference is now made to FIG. 3, which is a flowchart of a method of creating a metadata for indexing by a search engine according to an establishment classified into an establishment-category based on an image of a sign extracted from a street-view image, in accordance with some embodiments of the present invention. Reference is also made to FIG. 4, which is a block diagram of components of a system 400 for receiving as input a street-view image, extracting an image of a sign indicative of an establishment, classifying the establishment into an establishment-category by matching the image of the sign to an entry in an establishment-sign dataset, and creating metadata for indexing by a search engine, in accordance with some embodiments of the present invention. System 400 may implement the acts of the method described with reference to FIG. 3, by processor(s) 402 of a computing device 404 executing code instructions stored in a program store 406.

Computing device 404 receives one or more street-level images for processing (i.e., to classify establishment-categories of establishments according to associated signs) captured by a camera 408. The image may be provided by camera 408 and/or obtained from a street-level image repository 407 stored on a storage device (e.g., network server(s)). Camera 408 may be implemented as, for example, a digital camera, a video camera, and an imaging sensor. Camera 408 may capture two dimensional (2D) digital images, in color (e.g., red, green, blue based) and/or in black and white.

Camera 408 may be associated with a geographic positioning device 450 (e.g., global positioning sensor) that outputs a geographic location of camera 408 when the street-level image is captured, for example, longitude and latitude coordinates, and/or street intersections and/or street addresses.

Computing device 404 receives the street-level image(s) from street-level repository 407 and/or captured by camera 408 via one or more image interface(s) 410, for example, a wire connection, a wireless connection, other physical interface implementations, and/or virtual interfaces (e.g., software interface, application programming interface (API), software development kit (SDK)).

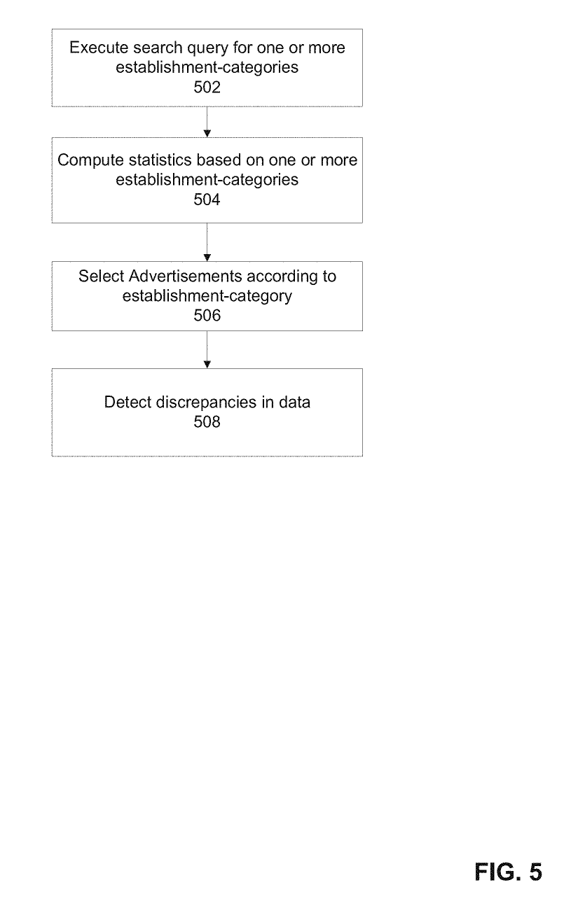

Computing device 404 may be implemented as, for example, a client terminal, a server, a computing cloud, a mobile device, a desktop computer, a thin client, a Smartphone, a Tablet computer, a laptop computer, a wearable computer, glasses computer, and a watch computer. Computing device 404 may include locally stored software that performs one or more of the acts described with reference to FIG. 3 and/or FIG. 5, and/or may act as one or more servers (e.g., network server, web server, a computing cloud) that provides services (e.g., one or more of the acts described with reference to FIG. 3 and/or FIG. 5) to one or more client terminals 412 over a network 414, for example, providing software as a service (SaaS) to the client terminal(s) 412, providing software services accessible via a software interface (e.g., API, SDK, processing of received queries), providing an application for local download to the client terminal(s) 412, and/or providing functions via a remote access session to the client terminals 412, such as through a web browser.

Processor(s) 402 of computing device 404 may be implemented, for example, as a central processing unit(s) (CPU), a graphics processing unit(s) (GPU), field programmable gate array(s) (FPGA), digital signal processor(s) (DSP), and application specific integrated circuit(s) (ASIC). Processor(s) 404 may include one or more processors (homogenous or heterogeneous), which may be arranged for parallel processing, as clusters and/or as one or more multi core processing units.

Storage device (also known herein as a program store, e.g., a memory) 406 stores code instructions implementable by processor(s) 402, for example, a random access memory (RAM), read-only memory (ROM), and/or a storage device, for example, non-volatile memory, magnetic media, semiconductor memory devices, hard drive, removable storage, and optical media (e.g., DVD, CD-ROM). Storage device 406 stores image analysis code instructions 406A that executes one or more acts of the method described with reference to FIG. 3 and/or FIG. 5. Storage device may store sign extractor code 406B of a trained machine learning method that identifies signs in a street-level image, as described herein.

Computing device 404 may include a data repository 416 for storing data, for example, an establishment-sign dataset 416A that stores signs of establishments and metadata associated with the establishment including an establishment-category, and an establishment-category dataset 416B that stores the classified establishment-categories, as described herein. Data repository 416 may be implemented as, for example, a memory, a local hard-drive, a removable storage unit, an optical disk, a storage device, and/or as a remote server and/or computing cloud (e.g., accessed via a network connection). It is noted that establishment-sign dataset 416A may be stored in data storage device 406, for example, executing portions are loaded from data repository 416 into data storage device 406 for execution by processor(s) 402.

Computing device 404 may include a network interface 418 for connecting to network 414, for example, one or more of, a network interface card, a wireless interface to connect to a wireless network, a physical interface for connecting to a cable for network connectivity, a virtual interface implemented in software, network communication software providing higher layers of network connectivity, and/or other implementations. Computing device 404 may access one or more remote servers 420 and/or storage devices 422 via network 414, for example, to download additional training images of additional object categories, and/or to provide the identification of the categories of the target images in the received image.

Computing device 404 may connect via network 414 (or another communication channel, such as through a direct link (e.g., cable, wireless) and/or indirect link (e.g., via an intermediary computing unit such as a server, and/or via a storage device) with one or more of:
Client terminal(s) 412 (which may include server(s)), for example, when computing device 404 acts as a server providing SaaS, and/or providing software services to other servers (e.g., mapping servers, map search servers, and vehicle navigation applications). The client terminals 412 may each provide one or more street-level images to computing device 404 for analysis over network 414. It is noted that camera 408 (and/or a storage device storing the captured image) may be connected to client terminal 412, providing the street-level image via network 414. For example, a user walking along a street may capture the street-level image with a camera on a Smartphone. The street-level image is transmitted to computing device 404 over network 414 for determining the establishment-category of the establishments captured in the street-level image. The establishment-category may be presented on the display of the mobile device, for example, as described herein. A query may be entered by the user on the mobile device and transmitted with the street-level image, for example, “which restaurant serves Italian Food?”.
Remotely located search engine server(s) 420 that receive the metadata for indexing. Search engine server 420 indexes the metadata. Exemplary search engine server(s) 420 include map search engines and/or statistical analysis servers.
Storage device 422 that stores establishment-sign dataset 416A, for example, a server of a government trademark office. Storage device 422 may include, for example, a storage server, a computing cloud storage server, or other implementations.

Computing device 404, and/or client terminal(s) 412 include and/or are in communication with a user interface 424 allowing a user to enter data (e.g., designate the street-level image, manually annotate sign(s) on street-level image(s) for training the machine learning method to identify signs) and/or view presented data (e.g., view the street-level image and/or map annotated with establishment-categories). Exemplary user interfaces 424 include, for example, one or more of, a touchscreen, a display, a keyboard, a mouse, and voice activated software using speakers and microphone.

Referring now back to FIG. 3, at 302, one or more street-level images are received by computing device 404. The street-level image(s) may be provided, for example, by a user capturing the street-level image with camera 408 of a mobile device, by a storage server storing street-view images that are presented on webpage and/or are searchable by a map search engine.

Optionally, a geographical location associated with the street-level image is received by computing device 404. The geographic location may be outputted by geographical positioning device 450. The street-level image may be tagged with a geo-tag of the geographic location. Alternatively, the street-level image is received without the geographical location. In such a case, the geographical location may be automatically obtained from an entry of the establishment-sign dataset, as described herein.

At 304, one or more signs each indicative of an establishment are identified within portions of each street-level image. Each identified sign is extracted as an image (i.e., the portion) from the street-level image.

The signs may include sign boards, for example, a rectangular (or other geometrical shape) backboard on which the name and/or logo of the establishment is printed or bonded. The sign may include letters and/or graphics of the name and/or logo of the establishment without necessarily having a proper sign board, for example, the letters and/or graphic of the name and/or logo of the establishment are connected to the wall directly without a board.

The identification may be performed by code of a machine learning method, optionally a deep learning detector, that is trained on a dataset of training street-level images with signs annotated according to a polygon or other geometric border. The signs may be manually annotated on the training street-level images, and/or may be automatically annotated with image processing code instructions. The annotation may include defining a border around the sign, optionally a rectangle or square, with other shapes (e.g., semi-circle), and/or segments that enclose the sign. It is noted that additional metadata does not necessarily need to be entered manually by the annotator, for example, content of the sign, such as the name of the establishment.

The deep learning detector receives the street-level image, and outputs one or more regions within the street-level image that include a sign.

The sign(s) includes image(s). The sign may include text that is unrecognizable (or recognizable with significant errors), for example, according to optical character recognition (OCR) methods. Exemplary signs include logos and/or trademarks of establishments, which may include pictures(s) and/or text that is unrecognizable (or recognized with errors) by OCR methods. It is noted that such signs may be un-analyzable by standard methods that are based on performing OCR methods to extract text. By analyzing the images of the signs and/or features of text of the signs, the accuracy of analyzing the sign is increased relative to OCR based methods.

It is noted that in cases when the sign includes text that may be extracted according to OCR, the systems and/or methods and/or code instructions described herein may treat the text as an image, and match the image of the text, optionally by extracting visual features from the image of the text.

It is noted that OCR may be used and complemented with the systems and/or methods and/or code instructions described herein that perform matching based on image(s) and/or other non-OCR text features.

The identified sign(s) are non-traffic and non-street name signs. The traffic and street name signs may be excluded (i.e., not identified) by the trained deep learning detector, which is trained on the sign dataset that excludes traffic and street name signs. Alternatively or additionally, the trained deep learning detect identifies non-traffic and non-street name signs, with such signs being unmatchable to an entry in the establishment-sign dataset, and therefore unclassifiable. It is noted that establishments that have signs that are similar to traffic and/or street name signs may be classified by identifying such signs and including entries to such establishments in the establishment-sign database. For example, a restaurant called 1342 5^{th} Avenue, and a clothing store called STOP!! may be identified.

Optionally, multiple common identified signs from a common street-level image, or from multiple street-level images are clustered. Each cluster may denote a common retail chain, franchise, and/or distribution network of establishments having multiple branches and/or distribution nodes at different geographical locations. For example, signs of a fast food franchise are identified at street-level images captured at different cities. Each cluster is associated with a single image.

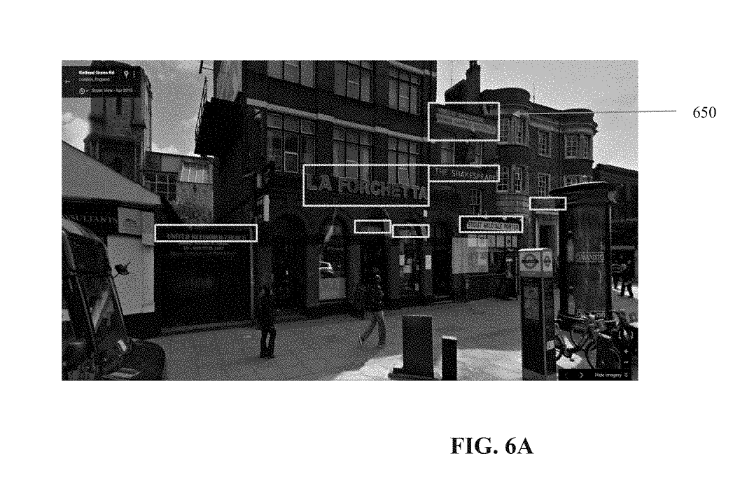

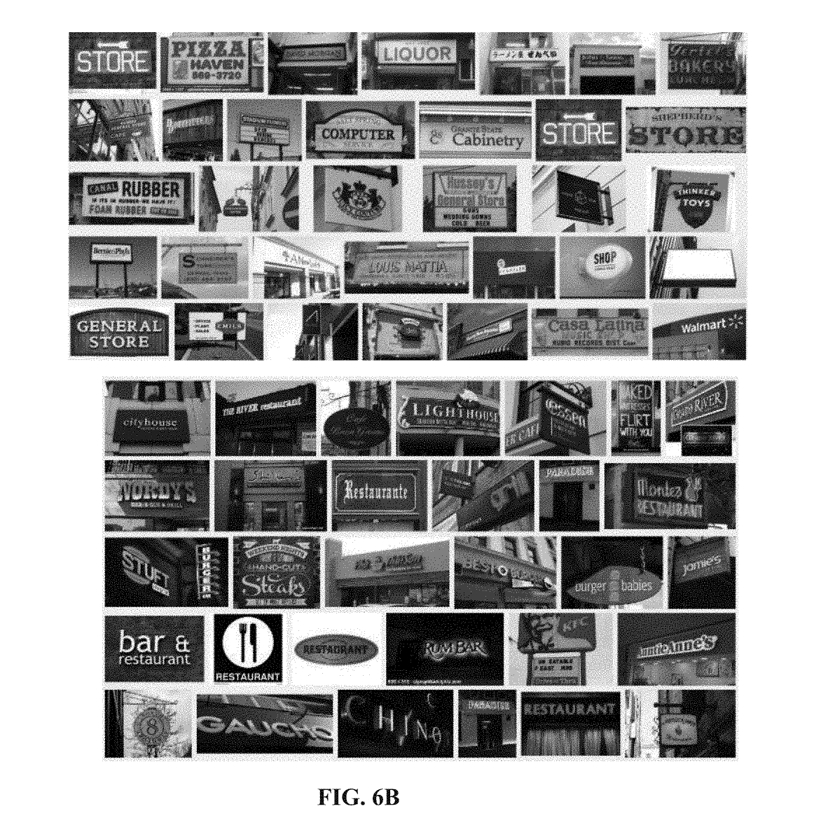

Reference is now made to FIG. 6A, which depicts automatically identified signs from the street-level image of FIG. 1, in accordance with some embodiments of the present invention. The automatically identified signs are marked with a rectangle (e.g., arrow 650 points to one rectangle as an example). The identified signs may be extracted within the bounding rectangles, classified into an establishment-category, and/or presented within an overlay, as described herein.

Reference is now made to FIG. 6B, which includes images of cropped signs identified and extracted from street-level images, in accordance with some embodiments of the present invention.

Referring now back to FIG. 3, at 306, the establishment associated with the identified sign is classified into an establishment-category. Each sign identified in the street-level image is matched to a corresponding entry in establishment-sign dataset 416A.

Each entry of establishment-sign dataset 416A includes a sign and/or features extracted from the sign, and an associated establishment-category. The matched signs include images and/or text unrecognizable according to OCR methods.

Each entry may include additional metadata associated with the matched sign, for example, the name of the establishment associated with the matched sign, and/or geographical location of the establishment associated with the matched sign. It is noted that one matched sign may be associated with multiple establishments at different geographical locations, for example, when the sign is indicative of a retail chain and/or franchise and/or distribution network of establishments, for example, bank branches, and branches of a fast food restaurant (e.g., including sit-down locations, drive-through branches, and walk-up kiosks).

Establishment-sign dataset 416A may include an existing publicly available dataset, for example, a dataset of registered trademarks.

Establishment-sign dataset 416A excludes traffic signs and street name signs. Entries for establishments having signs that are based on traffic signs and street name signs are included, as discussed above.

Establishment-sign dataset 416A may be automatically created by the following exemplary method: Multiple street-level images are received. The street-level images may cover a large geographical region, for example, multiple cities, a state, a country, and/or multiple countries. Portions of the street-level images that include signs are identified, for example, using the trained deep learning detector, as described herein. The portions that include signs are clustered according to visual features extracted from the portion. Each cluster includes portions of signs that represent a single establishment, for example, signs of a branches of a retail chain. Web crawler code instructions crawl along web documents (e.g., web pages) of a network (e.g., the internet, and/or another public network, for example, social networking sites), collecting logos, pictures, trademarks, and/or online images of signs of establishments. The web crawler may use the trained deep learning detector to identify and extract signs of establishments from images and/or web pages on the internet. The web crawler extracts the establishment-category associated with the collected logo, picture, trademark, and/or image of the sign. For example, the web crawler may analyze a tourism webpage of a small town. The tourism website is organized by establishment-category web pages, such as restaurants, grocery stores, and clothing stores. The web crawler extracts thumbnails of logos of local shops from each establishment-category webpage. The web crawler may extract additional metadata associated with each logo, trademark, picture, and/or image of the sign, optionally a geographic location of the establishment (e.g., street address), opening hours, and phone number. The signs extracted by the web crawler are visually matched (e.g., according to a correlation between extracted visual features) with the cluster to create entries of the establishment database (e.g., each cluster denotes one entry). The data indicative of the establishment-categories collected by the web crawler is included within respective clusters.

The extracted sign may be pre-processed prior execution of the matching process. The identified signs may be cropped from the street-view image. The identified signs may be rectified to a predefined geometric shape, for example, a rectangle. The identified sign may be annotated according to the street orientation side (e.g., according to metadata indicating the side of the street). The identified sign may be annotated with a more accurate location within the street-view image. The more accurate location (also referred to herein as a sub-geographic location) may be computed, for example, relative to identified streets and/or buildings within the street-level image. The streets and/or buildings within the street-level image may be identified, for example, based on geographical coordinates (e.g., geotag) outputted by the camera capturing the street-level image (e.g., from a geographical positioning device), and/or based on map service information (e.g., obtained from a mapping server). The identified sign may be annotated with the text extracted from the sign according to OCR.

The matching may be performed based on visual features extracted from the identified signs, which are matched to entries in establishment-sign dataset 416A storing non-textual visual features. The matching may be performed for a portion of the sign, for example, to account for errors in capturing the sign in the street-level image, and/or aberrations in the sign such as due to shadows and/or blocking objects. Exemplary features include, for example, SIFT (scale invariant feature transform), and/or text extracted according to OCR methods. The matching may be performed according to a matching requirement, for example, defining a probability that the extracted sign correlates to a certain entry of establishment-sign dataset 416A.

When common signs of an establishment retail chain, franchise, and/or distribution network having branches at various geographical locations are clustered (as described with reference to block 304), the single sign associated with the cluster is matched with an entry in establishment-sign dataset 416A.

At 308, metadata (e.g., a geo-tag, a search index) is automatically created for the street-level image. The metadata stores the classified establishment-category of each sign identified within the street-level image, and the geographic location. The geographic location for the establishment may be obtained from geographic positioning device 450, and/or from the matched entry of the establishment-sign dataset.

A geo-tag may be created for the establishment associated with the identified sign(s) (and/or for the sign itself) extracted from the street-level image. The metadata may be stored in the geo-tag.

The metadata may be used for indexing of the street-level image by a map search engine, as described herein.

Metadata used as a geo-tag may be created for establishments that are not currently tagged, for example, when geo-tags are manually created and no user entered data to manually create the geo-tag for the establishment. Alternatively, existing geo-tags are updated with the classified establishment-category of the sign(s) and/or with the geographic location. Alternatively, discrepancies with data stored in existing geo-tags is identified and optionally corrected, as described herein.

Optionally, the establishment-category of the matched entry is associated with the sign indicative of the establishment of the street-level image. When the matching is performed according to a common sign of a cluster of establishments, each member of the cluster is associated with the establishment-category of the matched entry.

The association may be performed according to a data structure that stores establishment-categories and the extracted sign, for example, the establishment-category dataset described herein, and/or other data structures, for example, a database, a metadata tag, and/or an array of points and/or links.

Optionally, a cluster of establishments, which are not part of the same establishment retail chain, franchise, and/or distribution network, is created based on a common establishment-category. The cluster may be defined for a certain geographical region, for example, a city, multiple cities, a county or state, multiple counties or states, a country, multiple countries, or according to other defined geographical regions (e.g., streets, highways, water landmarks, mountains, and latitude and longitude coordinates), and the world. For example, Jack's Place, Fine Eatn, and The Egg Roll, acquired from images of a downtown city, are clustered into the Restaurants cluster.

Each establishment member of each establishment-category cluster is identified according to a common indication indicative of the establishment-category. For example, metadata stored as a tag with the street-level image.

At 309, the metadata is provided for indexing by a search engine, optionally a map search server. The indexed metadata is searchable for establishments satisfying at least one queried establishment-category within a queried geographical region.

The metadata may be provided for example, via a software interface, such as an API, SDK, or other methods. The search engine may be an external search engine server 420, and/or may be locally stored on computing device 404. The metadata may be used to index the street-level image, and/or to create another index independent of the street-level image that may be used to perform a statistical analysis (as described herein).

The metadata may be used to create a geo-tag for the street-level image. The street-level image may be indexed and/or searched according to the geo-tag.

The created metadata may be provided to the client terminal that transmitted the street-level image, and/or to another computing device for association with the street-level image.

Alternatively or additionally, the metadata may be used to create and/or update a dataset with the establishment categories. The metadata may be used to create and/or update a geo-tag associated with the street-level image. The metadata may be used to create and/or update a street map (e.g., 2D and/or 3D) by mapping the geographic location of the establishment(s) and/or street-level image to the respective establishment-category. The geographic location of the establishment may be obtained, for example, from a positioning device (e.g., global positioning sensor) on the camera that captured the street-level image, from the entry of the establishment-sign dataset, and/or from data stored in association with the map itself.

Additional details of searching the indexed metadata is described with reference to block 502. Additional details of performing a statistical analysis according to the indexed metadata is described with reference to block 504. Additional details of creating another dataset according to the metadata is described with reference to block 312.

At 310, the establishment-category matched for the sign(s) of street-level image(s) is provided for presentation to a user. The establishment-category may be presented as an overlay of the street-level image, optionally as an overlay of the sign.

The overlay may be generated as an overlay within a graphical user interface (GUI) presenting a street map that includes a geographical location corresponding to the geographical location captured in the street-level image. The map may be an online map, and/or an online traffic navigation application. The map may be a 2D or 3D map.

The geographical location of the establishment may be obtained from the matched entry, and/or from an existing geographical location associated with the online street map. The overlay includes the establishment-category positioned according to the geographical location. For example, the word restaurant is positioned over a geographical location corresponding to a sign extracted from the street-level image that is matched to the establishment-category restaurant.

Alternatively or additionally, the overlay of the online street map presents an image (e.g., cropped thumbnail) of the identified sign positioned according to the geographical location of the establishment. The presented image may be the image of the sign extracted from the street-level image, and/or the image, logo, picture, and/or trademark associated with the matched entry.

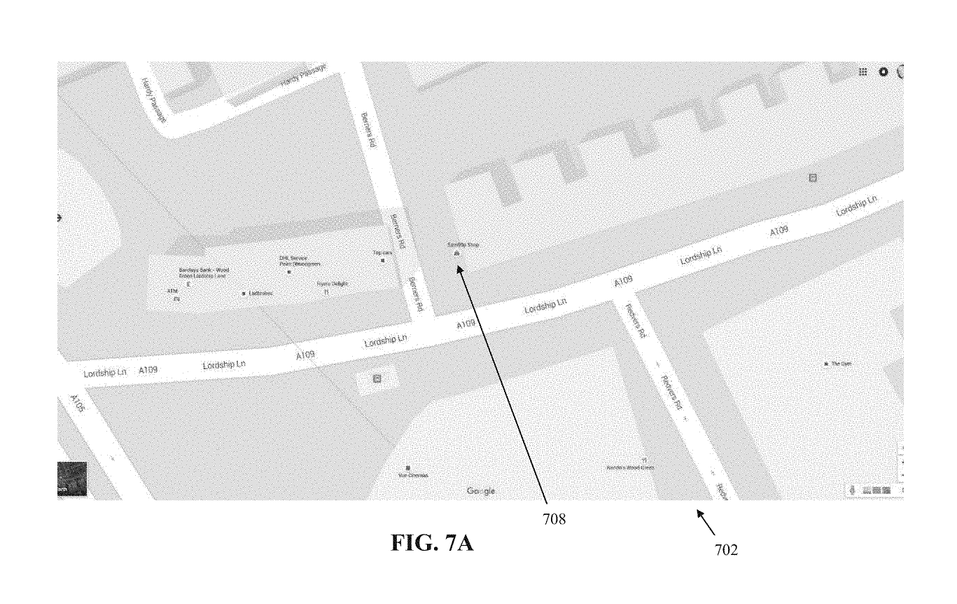

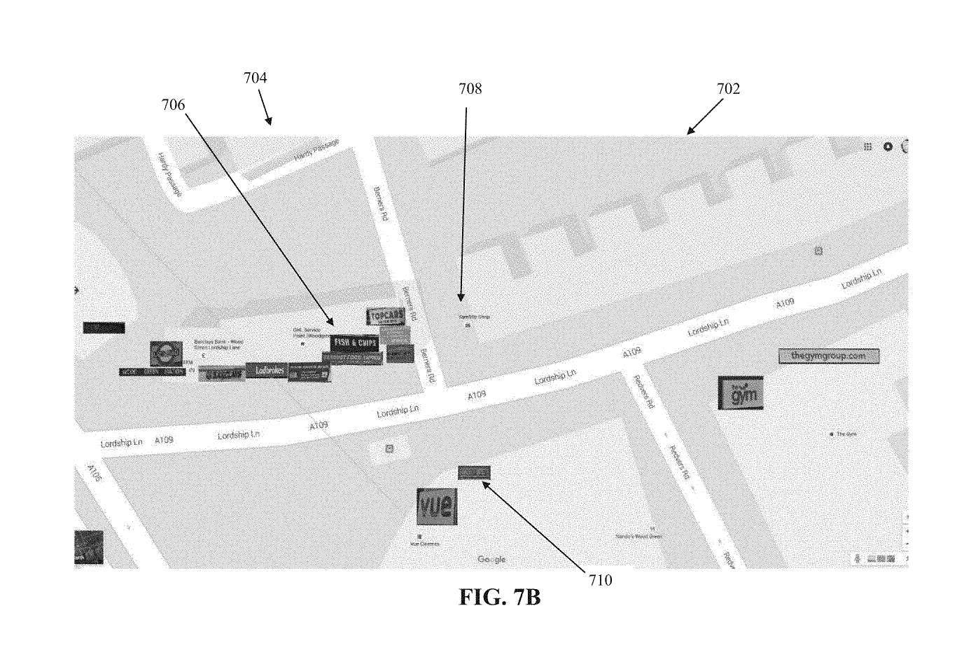

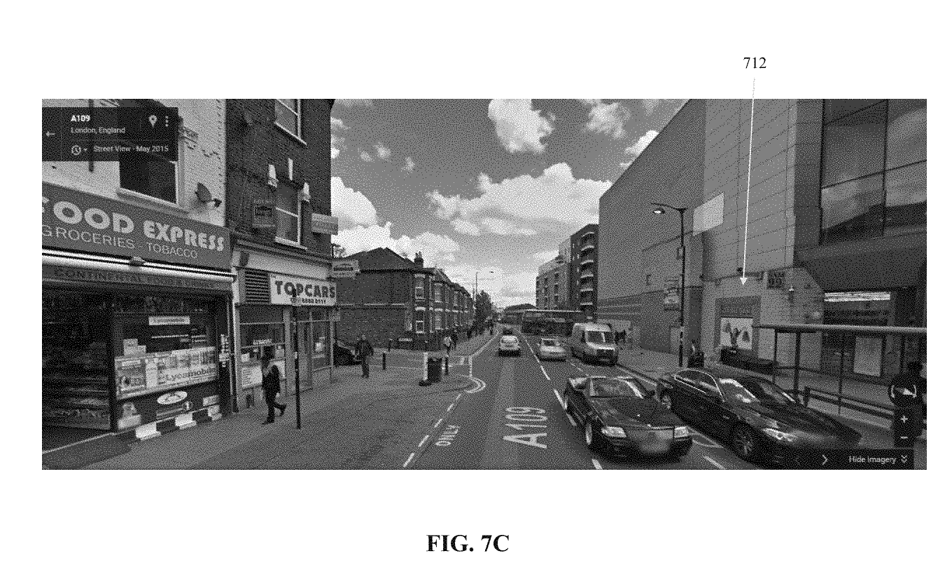

Reference is now made to FIG. 7A, which includes an example of a map 702 without the overlay created by the systems and/or methods and/or code instructions described herein, in accordance with some embodiments of the present invention. Map 702 depicts geographical location(s) captured in one or more street-level images. FIG. 7B includes an overlap 704 over map 702 (of FIG. 7A) that includes cropped images of signs (e.g., thumbnails 706 710) extracted from the street-level image(s), in accordance with some embodiments of the present invention. Overlap 704 may include the classified establishment-category associated with the displayed sign(s).

Referring now back to FIG. 3, at 312, an establishment-category dataset 416B that stores the classified establishment-categories of the establishments indicated in the identified signs of the street-level image(s) is created and/or updated according to the metadata created for each street-level image.

The establishment-category dataset 416B may store the establishment-categories mapped to geographical locations of the establishments and/or mapped to the street-level image(s). The geographic locations of the street-level images may be obtained, for example, according to a global positioning device associated with the camera that captured the 3 street-level image, for example, a global positioning system (GPS) device that outputs coordinates of the camera that captured the street-level image.

The establishment-category dataset 416B may store the clusters of establishment-categories.

The establishment-category dataset 416B may store text of the sign extractable according to OCR methods.

The establishment-category dataset 416B may store associated institutions.

The establishment-category dataset 416B may be created and/or updated by computing device 404 and/or by another computing device, for example, a third entity server 420, for example, a map search server.

Referring now back to FIGS. 7A-7B, establishments that do not appear in map 702 are displayed according to overlap 704 optionally according to data from the establishment-category dataset, for example, establishment that do not have manually entries and/or manually created geo-tags may be displayed according to overlap 704 in associated with automatically created metadata and/or automatically created geo-tags (used for indexing the street-level image(s) and/or establishment), as described herein. For example, the sign for establishment “Fish and Chips” 706 appears in overlap 704, but is absent from map 702. An entry for Fish and Chips 706 may be created in the establishment-category dataset and used for indexing and/or creating the geo-tag for the street-level image(s) that include Fish and Chips 706 sign.

Reference is now made to FIG. 5, which is a flowchart depicting features that are executed based on the metadata and/or based on the establishment-category dataset (e.g., establishment-category dataset 416B described with reference to FIGS. 3-4), in accordance with some embodiments of the present invention. The indexed metadata and/or establishment-category dataset may be searched according to a textual search query, used to compute statistics of establishment-categories over a certain geographical region, used to select relevant advertisements, used to automatically create a geo-tag for indexing of the street-level image, and/or to detect discrepancies with existing data.

The indexed metadata and/or establishment-category dataset may be stored on and/or in association with computing device 404. The indexed metadata and/or establishment-category dataset may be accessed by client terminal(s) 412 and/or server(s) 420 over network 414 via a web page and/or other network session. The indexed metadata and/or establishment-category dataset may be accessed by an application (or other code instructions) executing on client terminal(s) 412 and/or server(s) 420 that communicates with establishment-category dataset stored on computing device 404 via a software interface (e.g., API, SDK).

At 502, a search query is received for searching the indexed metadata and/or establishment-category dataset. As described herein, the indexed metadata and/or establishment-category dataset may include, for example, a dataset of street-level images indexed according to the created metadata storing the classified establishment categories associated with the street-level image, a street map (e.g., 2D, 3D) having geographic locations corresponding to the street-level images and/or establishments mapped to the classified establishment-categories.

The search query includes one or more establishment-categories and may include a defined geographical region for searching for the establishment-categories. The search query may be received from a map search engine via an API of computing device 404, to execute a user entered search query on a street map and/or street-level images. The search query may be received directly from a user via a web page to access computing device 404, for example, to search for street-level images of establishments satisfying the establishment-category query within the certain geographic region. The search query may be textual.

Examples of search queries:
“All establishments on the east side of Maddison Street, New York City”
“Doctor offices associated with the HMO ABCDE”
“What businesses are located in this image”
“Which of the stores in front of me have orthopedic shoes?”
“Menus of restaurants in this image”

The search results may include a presentation of a distribution of the establishment members of the cluster of the establishment-category in the search query over the certain geographical area of the search query. The search results may be presented as a graphical overlap over a street map, and/or over one or more street-level images. For example, when the search query is for “restaurants downtown Centerville”, the presentation may include a street map of downtown Centerville with an overlap (e.g., tags, dots) mapping establishments having the establishment-category restaurant (e.g., members of the restaurant cluster). In another example, the presentation may include one or more street-level images of downtown Centerville with an overlap (e.g., colored outlines of the signs of the establishments, arrows pointing to the establishments) mapping establishments having the establishment-category restaurant.

At 504, a statistical analysis is performed based on establishment-categories within a certain geographical area, optionally members of one or more clusters of establishment-categories. The statistical analysis may be performed based on the results of the search query.

The statistical analysis may be performed in association with data obtained from another database, for example, a demographic database with data of population within the certain geographical area.

The statistical analysis may be performed based on instructions received from a remote server via a software interface (e.g., API), and/or based on instructions received from a user using a client terminal (e.g., a GUI for selecting the desired statistical analysis).

Examples of statistical analysis include:
A distribution of kindergartens, schools, high-schools, and higher level education institutes within a defined geographical area.
A distribution of financial institutions within a defined geographical area, for example, bank branches, automated teller machines (ATMs), and investment consultants.
A distribution of government offices within a defined geographical area, for example.
All establishments located between 5^{th} and 7^{th} Avenue, and 40^{th} and 43^{rd} Street, Manhattan, New York City.

The distribution analysis may be used, for example, by city planner to determine where addition schools are needed, by banks to determine where additional bank branches are needed, and by government to determine underserviced areas. The statistical analysis may be performed in association with external data, for example, the distribution of income, ages, and/or current unemployment rate for the certain geographical region.

At 506, an advertising database may be accessed to retrieve one or more stored advertisement of products and/or services associated with the classified establishment-category, and/or associated with the establishment-category of the search query. The advertising database may be accessed, for example, by computing device 404, and/or by the map search engine that presents the overlay that includes the classified establishment-category, and/or by an application executing on the client terminal of the user that transmitted the captured street-level image. The advertising database may be accessed by transmitting a request for advertisements by transmitting the classified establishment-category.

The received advertisement may be presented in association with the street-level image and/or a map of a location of the establishment. For example, as a window and/or as an overlay.

It is noted that the received advertisement(s) are not necessarily related to the establishment indicated in the sign that was identified and used to classify the establishment-category. For example, the sign may be of a certain clothing store. The advertisement(s) presented may be for another clothing store, which may be a competitor of the certain clothing store.

At 508, a discrepancy may be detected between the geographic location of the establishment obtained from the entry and a manually created geo-tag of the street-level image.

Alternatively or additionally, a discrepancy is detected between an existing manually entered establishment-category associated with the street-level image and the classified establishment-category.

Alternatively or additionally, a discrepancy is detected between the geographic location of the created geo-tag for the street-level image that stores the establishment-category for each identified sign, and a manually created geo-tag of the street-level image.

Alternatively or additionally, a discrepancy is detected between the geographic location received from the geographical positioning device that outputted the location of the camera that captured the street-level image, and a manually created geo-tag of the street-level image.

When a discrepancy is detected, an automatic correction may be made to the manually created geo-tag according to the geographic location obtained from the entry of the establishment-sign dataset. The automatic correction may be made to the existing manually entered establishment-category associated with the street-level image according to the classified establishment-category.

An alert may be generated indicative of the discrepancy, and the user may be prompted to automatically correct the discrepancy, or indicate that the data of the manually created geo-tag is correct. The alert may be presented to the user of the client terminal and/or server that transmitted the street-level image, for example, as a message in the GUI used to instruct the transmission of the street-level image.

Referring now back to FIGS. 7A-7B, a discrepancy for the establishment Sam99p is identified and automatically corrected. Map 702 shows the location of Sam99p according to location indicator 708 at a different location than location 710 where the sign for the establishment Sam99p is presented according to overlay 704. Location indicator 708 indicates that the location of Sam99p is at the corner of A109 and Berners Rd. The actual location of the sign of Sam99p is identified and automatically extracted (as described herein) from the street-level image depicted in FIG. 7C. The actual location of Sam99p is across the street, on the Vue Building, and depicted by arrow 712 of FIG. 7C. Overlay 704 depicts the corrected location of 710 of Sam99p. The index metadata and/or geo-tag of the street-level image may be automatically corrected.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant cameras capturing street-level images will be developed and the scope of the term street-level image is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A computer implemented method of classifying an establishment within a street-level image into an establishment-category for indexing by a search engine, the method comprising:
receiving a street-level image and a geographic location;
identifying at least one portion of the street-level image including a sign indicative of at least one establishment;
classifying each of the at least one establishment into an establishment-category by matching each extracted sign image portion to a corresponding entry in an establishment-sign dataset, wherein entries of the establishment-sign dataset include at least one image of a certain sign and an associated establishment-category of the certain sign;
creating, for the street-level image, metadata that stores each classified establishment-category and the geographic location; and
providing the metadata for indexing by a search engine, wherein the indexed metadata is searchable for establishments satisfying at least one queried establishment-category within a queried geographical region.

2. The method of claim 1, wherein the matching is performed based on visual features extracted from the portion of the street-level image that are matched to visual features stored in the establishment-sign dataset.

3. The method of claim 1, wherein receiving comprises receiving a plurality of street-level images of a geographical region, wherein identifying comprises identifying a plurality of portions of the plurality of street-level images each including a sign indicative of a respective establishment, and further comprising:
clustering the plurality of establishments of the geographical region according to the respective classified establishment-categories, and
identifying establishment members of each cluster of establishment-categories according to a common indication.

4. The method of claim 1, further comprising:
receiving a textual search query for a certain establishment-category and a certain geographical area;
searching, according to the metadata, for the certain establishment-category and the certain geographical area; and
presenting a distribution of establishments of the certain establishment-category within the certain geographical area.

5. The method of claim 4, further comprising:
performing a statistical analysis based on at least one establishment-category within a certain geographical area, according to the created metadata.

6. The method of claim 1, wherein receiving comprises receiving a plurality of street-level images of a geographical region, wherein identifying comprises identifying a plurality of portions of the plurality of street-level images including a plurality of sign indicative of a plurality of establishments, and further comprising:
clustering the plurality of signs of the plurality of establishments according to common identified signs; and
classifying the plurality of establishment members of each cluster into an establishment-category by matching the common identified sign of each cluster to the corresponding entry in the establishment-sign dataset.

7. The method of claim 6, wherein each cluster denotes at least one of: a retail chain, a franchise, and a distribution network of establishments with a plurality of branches at different locations within the geographical region, wherein the at least one of: retail chain, franchise, and distribution network of establishments is associated with a common sign.

8. The method of claim 1, wherein the identifying at least one portion of the street-level image including the sign is performed by code of a deep learning detector that is trained on a dataset of training street-level images with signs annotated with a polygon.

9. The method of claim 1, further comprising: generating an overlay over a map that includes the geographical location from which the street-level image is acquired, the overlay including the establishment-category positioned according to the geographical location.

10. The method of claim 9, wherein the overlay further presents a cropped thumbnail of the identified at least one portion of the street-level image including the sign positioned according to the geographical location.

11. The method of claim 1, wherein the at least one portion of the street-level image including the sign includes at least one of a logo, a picture, and a trademark of the establishment, and the establishment-sign dataset includes at least one of a logo database, a picture database, and a trademark database.

12. The method of claim 1, wherein the establishment-sign dataset is automatically created by performing:
receiving a plurality of street-level images;
identifying a plurality of portions from the plurality of street-level images including a plurality of signs;
clustering the plurality of signs according to visual features extracted from each sign;
crawling, using web crawler code instruction executable by at least one hardware processor, along web documents of a network, collecting at least one of logos and trademarks of establishments and data indicative of the establishment-category associated with the at least one of logos and trademarks;
creating a plurality of entries of the establishment-sign dataset by visually matching the collected at least one of logos and trademarks of establishments to respective clusters of signs and including within each respective entry the data indicative of the respective establishment-category.

13. The method of claim 1, further comprising:
obtaining a geographic location of the establishment from the corresponding entry of the establishment-sign dataset; and
storing within the created geo-tag of the street-level image, the identified portion of the street-level image including the sign based and the geographic location of the establishment.

14. The method of claim 1, further comprising: detecting a discrepancy between the geographic location of the created geo-tag for the street-level image that stores the establishment-category for each identified portion of the street-level image including the sign, and a previously created geo-tag of the street-level image.

15. The method of claim 1, further comprising: detecting a discrepancy between an existing manually entered establishment-category associated with the street-level image and the classified establishment-category.

16. The method of claim 1, further comprising: accessing an advertising database to retrieved at least one stored advertisement of at least one of products and services associated with the establishment-category, and presenting the at least one advertisement in association with at least one of the street-level image and a map of a location of the establishment.

17. The method of claim 1, further comprising: providing the metadata for indexing of the street-level image according to each classified establishment-category and the geographic location, wherein the indexed street-level image is searchable according to a search query of a certain establishment-category.

18. The method of claim 1, further comprising:
rectifying the identified portion of the street-level image including the sign to a geometric shape;
computing a sub-geographic location of the sign within the street-level image according to at least one of streets and buildings associated with the geographic location of the street-level image,
wherein the geographic location of the street-level image is obtained from at least one of: a geotag created by the camera that captured the street-level image and map service information obtained from a mapping server that stores geographic locations of at least one of streets and buildings; and
storing within the metadata the sub-geographic location of the sign.

19. A system for classifying an establishment within a street-level image into an establishment-category, the system comprising:
a non-transitory memory having stored thereon a code for execution by at least one hardware processor of a computing device, the code comprising:
code for receiving a street-level image and a geographic location;
code for identifying at least one portion of the street-level image including a sign indicative of at least one establishment;
code for classifying each of the at least one establishment into an establishment-category by matching each extracted sign image portion to a corresponding entry in an establishment-sign dataset, wherein entries of the establishment-sign dataset include at least one image of a certain sign and an associated establishment-category of the certain sign;
code for creating, for the street-level image, metadata that stores each classified establishment-category and the geographic location; and
code for providing the metadata for indexing by a search engine, wherein the indexed metadata is searchable for establishments satisfying at least one queried establishment-category within a queried geographical region.

20. A computer program product for classifying an establishment within a street-level image into an establishment-category, the computer program product comprising:
a non-transitory memory having stored thereon a code for execution by at least one hardware processor of a computing device, the code comprising:
instructions for receiving a street-level image and a geographic location;
instructions for identifying at least one portion of the street-level image including a sign indicative of at least one establishment;
instructions for classifying each of the at least one establishment into an establishment-category by matching each extracted sign image portion to a corresponding entry in an establishment-sign dataset, wherein entries of the establishment-sign dataset include at least one image of a certain sign and an associated establishment-category of the certain sign;
instructions for creating, for the street-level image, metadata that stores each classified establishment-category and the geographic location; and
instructions for providing the metadata for indexing by a search engine, wherein the indexed metadata is searchable for establishments satisfying at least one queried establishment-category within a queried geographical region.
